(19) United States
(12) Patent Application Publication
(10) Pub. No.: US 2008/0217800 A1
(43) Pub. Date: Sep. 11, 2008

(54) METHOD FOR STABILIZING LENS MOLD ASSEMBLY

(76) Inventors: Edward R. Kernick, Jacksonville, FL (US); Leslie A. Voss, Jacksonville, FL (US); H. Anthony Darabi, Ponte Vedra Beach, FL (US); Jason M. Tokaski, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/682,364

(22) Filed: Mar. 6, 2007

(51) Int. Cl. B29D 11/00

(52) U.S. Cl. 264/1.38

(57) ABSTRACT

The invention provides for partially curing a flash ring during mold assembly to make the ring sufficiently tacky so that the back mold half will remain adhered to the mold assembly during the subsequent cure processing.

### FIELD OF THE INVENTION

The invention relates to the manufacture of contact lenses. In particular, the invention provide for the production of contact lenses in which the flash ring is partially cured at the time of deposition of the back mold half.

### BACKGROUND OF THE INVENTION

Methods and molds useful in the manufacture of contact lenses are well known. For example, in U.S. Pat. No. 5,540,410, incorporated herein in its entirety by reference, are disclosed molds and their use in contact lens manufacture. Typically, two mold halves are assembled to form a mold having a mold cavity therebetween for lens formation. A reactive lens material is placed into one mold half and the second mold half is placed on the first mold half to complete the lens mold assembly.

Placement of the second mold half onto the first usually results in some overflow of the lens material from the mold cavity. Typically, the mold halves have flanges extending around and outwardly from the cavity and the excess material spreads out between the flanges forming a whole or partial ring of material outside of the mold cavity, which is called a flash ring.

In conventional contact lens manufacturing processes, a pre-cure step precedes curing of the lens material. In the pre-cure step, the mold assembly is exposed to actinic radiation for a time sufficient for the lens material to form a partially polymerized gel. Following pre-cure, the lens material cure is completed in a curing step during which the final lens is formed.

After curing of the lens material, the front and back mold halves must be separated from each other in order to remove the lens from the mold. Separation of the molds and removal of the lens may be inhibited by adhesive forces between the mold halves and the mold halves and the cured lens material due to the use of certain mold materials. The adhesive forces may be reduced by selection of other mold materials. However, selection of mold materials that reduce the adhesive forces can result in a back mold half that does not remain adhered to the lens material and front mold half when the mold is assembled. This allows the back mold half to move in relation to the front mold half, which movement produces variations in the center thickness of the lens.

Center thickness variations may be reduced by increasing the time in which the mold assembly is subjected to a pre-cure prior to curing. However, this is disadvantageous because it increases the overall cycle time for lens manufacture and decreases output from the production line.

### BRIEF DESCRIPTION OF THE DRAWINGS

FIG. 1 is a top planar view of a front curve mold half useful with the apparatus and method of the invention.

FIG. 1a is a cross sectional view of the mold half of FIG. 1 through I-I.

FIG. 2 is a top planar view of a back curve mold half useful with the apparatus and method of the invention.

FIG. 2a is a cross sectional view of the mold half of FIG. 2 through II-II.

FIG. 3 is an elevated bottom perspective view of the apparatus of the invention.

FIG. 4 is a side view of the apparatus of FIG. 3.

FIG. 5 is a view of the apparatus of FIG. 3 seating a back curve mold half onto a front curve mold half.

### DETAILED DESCRIPTION OF THE INVENTION AND PREFERRED EMBODIMENTS

The invention provides an apparatus for, and method in which, the flash ring is partially cured at the time the back mold half is deposited onto the front mold half to form the mold assembly. It is a discovery of the invention that, by using high-intensity actinic radiation at the time of assembling the back mold half with the front mold half, the flash ring can be cured to make it sufficiently tacky so that the back mold half will remain adhered to the mold assembly during the subsequent cure process reducing center thickness variations. Thus, in the method of the invention, the pre-cure step is combined with the mold assembly step and the need for a separate pre-cure step is substantially eliminated.

In one embodiment the invention provide a method comprising, consisting essentially of and consisting of: a) depositing a predetermined amount of a lens material in a first mold half; b.) assembling the first mold half with a second mold half to form a mold and a flash ring comprised of excess lens material; and c.) exposing, during step b.), the flash ring to an effective amount of high intensity actinic radiation for a time sufficient to partially cure the flash ring.

The apparatus of the invention provides for application of high-intensity actinic radiation to be applied to the lens mold assembly at the time of deposition of the back mold half onto the front mold half. Preferably, the actinic radiation is ultraviolet (“UV”) or visible light.

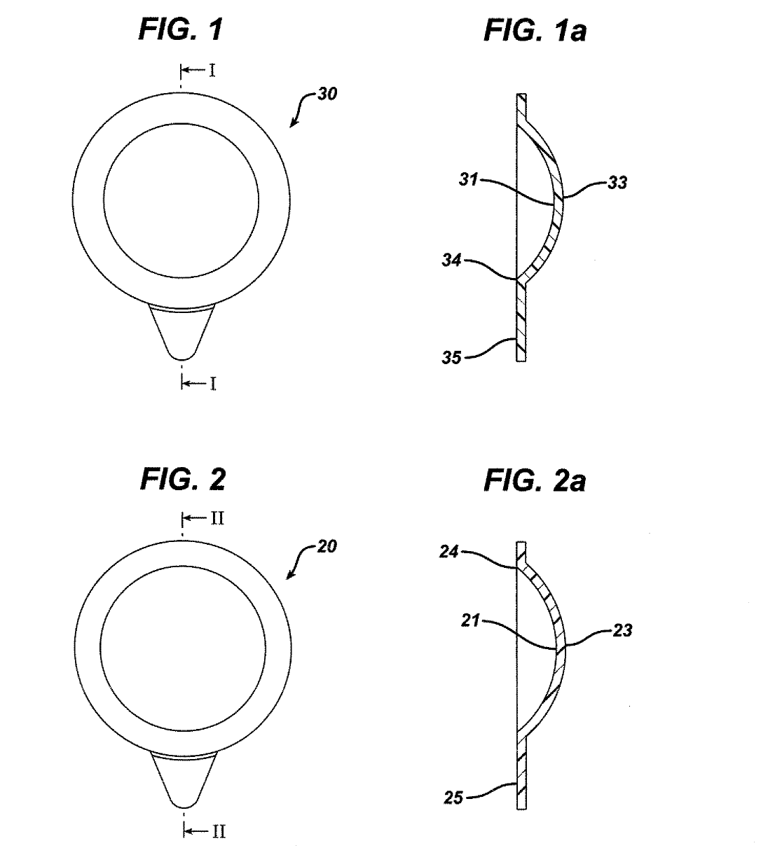

Typically, and with reference to FIGS. 1, 1a, 2 and 2a, soft contact lenses are formed in a mold composed of a front curve mold half 30 and a back curve mold half 20. Preferably, the mold halves are formed of any suitable material that is transparent to visible and ultraviolet light. The apparatus and method of the invention may find particular utility with molds formed from polyolefins including, without limitation, polystyrene, polypropylene and ZEONOR® 1060. Front curve and back curve mold halves 30 and 20, respectively, each have a central curved section defining a concave surface 31 and 21, respectively. Spaced apart from the concave surface is a convex surface 33 and 23, respectively. A circular circumferential edge, 34 and 24 respectively, extend around the concave surfaces and is integral with an annular essentially uniplanar flange, 35 and 25, respectively. At least a part of the concave surface 31 and the convex surface 23 have the dimensions of the front and back curves, respectively of a contact lens to be produced in the mold assembly, and are smooth so that the surface of the contact lens formed by polymerization of said polymerizable composition in contact with the surface is optically acceptable. Preferably, the mold is thin enough to transmit heat therethrough rapidly and has rigidity sufficient to withstand prying forces applied to separate the mold halves during demolding step which occurs after the cure step in the manufacturing process.

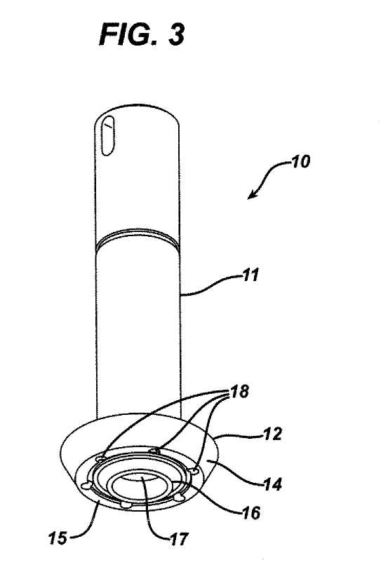

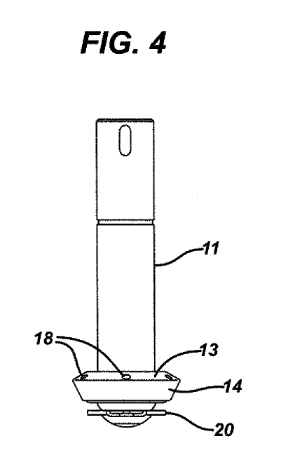

Referring to FIGS. 3 and 4, elevated perspective and side views of an apparatus suitable for use in the method of the invention is shown. The apparatus, back mold half deposition nozzle 10, includes an elongated shaft 11 that is fixedly attached to nozzle head 12. Nozzle head 12 is a vacuum head that picks up the back mold half and places it onto the front mold half. Nozzle 10 attaches to a deposition head, not shown, which deposition head is preferably an aluminum block with vacuum routed to it. Nozzle head 12 includes top surface 13, circumferential sidewall 14 and bottom surface 15. At the center of bottom surface 15 is alignment feature 16 and vacuum port 17. Top surface 13 has a plurality of openings 18 spaced therearound. The openings communicate with bottom surface 15 and are about 2 to about 2.7 mm, preferably about 2.2 to about 2.6 mm in diameter. The size and number of the openings will depend upon the size of the bottom and top surfaces of nozzle head 12 and the intensity and type of the light source used. In a preferred embodiment, 6 equally spaced-apart openings 18 are used.

In the method of the invention, a predetermined amount of lens material is deposited in the front mold half. Dosing may be carried out by any convenient method including, without limitation, use of a dosing nozzle, tubing or the like.

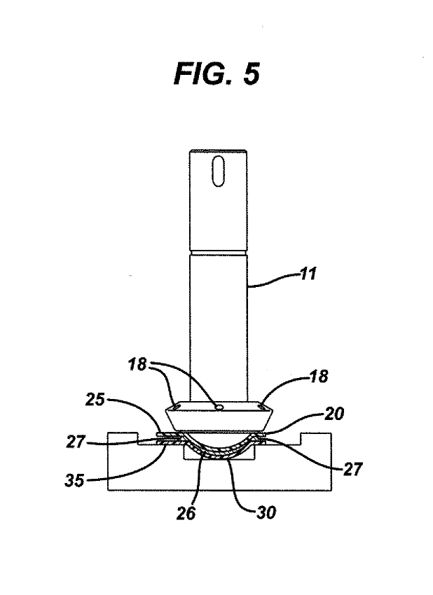

Referring to FIGS. 4 and 5, once dosing of the front curve mold half 30 is complete, nozzle head 12 with the back mold half 20 attached is positioned over the front mold half which contains the lens materials 26. Assembling of the front mold half with the back mold half is carried out using nozzle 10. The nozzle lowers back mold half 20 to, and seats it on, front mold half 30 and clamps the mold halves under pressure. The applied pressure may be any desirable pressure, but preferably is about 1 to about 5 pounds. As shown in FIG. 5, when the back curve mold half is seated onto the front curve mold half and the molds, excess lens material extrudes out of the mold cavity and lodges between flanges 25 and 35 to form the flash ring 27.

While nozzle head 12 is still affixed to back mold half 20, the flash ring 27 is subjected to a brief burst of high intensity actinic radiation from a source preferably located superiorly to top surface 13 of nozzle 10. Openings 18 permit exposure of the flash ring to the radiation. However, because nozzle 10 remains in place during the exposure, the lens material 24 is shielded from the radiation and is not irradiated. The radiation source used may be any commercially available source suitable for use in contact lens manufacturing. In the preferred embodiment, a UV lamp source is used which is a high pressure mercury vapor lamps capable of emitting ultraviolet radiation. An example of suitable radiation source is the OMNICURE 2000 available from EXFO Precision Assembly Group.

The actinic radiation used is UV, visible light, or both. The radiation used is high intensity meaning the intensity is about 0.2 mW/cm² to about 40 mW/cm². The amount of time of the exposure is a partial-cure effective amount meaning an amount of time sufficient to partially cure the flash ring, meaning that the lens material forming the flash ring becomes sufficiently tacky so that the back mold half remains adhered to the front mold half during subsequent curing of the lens material to form a lens. Thus, the length of exposure will be determined by the lens material used and the thickness of the flash ring formed by that material and intensity if the radiation used. Preferably, the time for exposure is about 0.1 to about 10 seconds, preferably about 0.1 to about 1 second, and more preferably about 0.2 to about 0.5 seconds.

The method of the invention may be useful in manufacture of any contact lenses, but may find particular utility in the manufacture of soft contact lenses. Suitable soft contact lens materials for use with the method of the invention include, without limitation, copolymers based on 2-hydroxyethyl methacrylate (“HEMA”) and one or more comonomers such as 2-hydroxyethyl acrylate, methyl acrylate, methyl methacrylate, vinyl pyrrolidone, N-vinyl acrylamide, hydroxypropyl methacrylate, isobutyl methacrylate, styrene, ethoxyethyl methacrylate, methoxy triethyleneglycol methacrylate, glycidyl methacrylate, diacetone acrylamide, vinyl acetate, acrylamide, hydroxytrimethylene acrylate, methoxyethyl methacrylate, acrylic acid, methacryl acid, glyceryl methacrylate, and dimethylamino ethyl acrylate. Additional useful materials include, without limitation silicone elastomers, silicone-containing macromers including, without limitation, those disclosed in U.S. Pat. Nos. 5,371,147, 5,314,960, and 5,057,578 incorporated in their entireties herein by reference, hydrogels, silicone-containing hydrogels, and the like and combinations thereof. More preferably, the surface is a siloxane, or contains a siloxane functionality, including, without limitation, polydimethyl siloxane macromers, methacryloxypropyl polyalkyl siloxanes, and mixtures thereof, silicone hydrogel or a hydrogel, such as etafilcon A.

What is claimed is:

1. A method, comprising the steps of: a) depositing a predetermined amount of a lens material in a first mold half, b.) assembling the first mold half with a second mold half to form a mold and a flash ring; and c.) exposing, during step b.), the flash ring to a partial-cure effective amount of high intensity actinic radiation for a time sufficient to partially cure the flash ring.

2. The method of claim 1, wherein the high intensity actinic radiation is ultraviolet radiation.

3. The method of claim 2 wherein the high intensity radiation is of an intensity of between about 0.2 mW/cm² to about 40 mW/cm² and the time of exposure is about 0.1 to about 10 seconds.
